(19) United States
(12) Patent Application Publication
(10) Pub. No.: US 2009/0013174 A1
(43) Pub. Date: Jan. 8, 2009

(54) METHODS AND SYSTEMS FOR HANDLING DIGITAL RIGHTS MANAGEMENT

(75) Inventors: George Foti, Dollard-des-Ormeaux (CA); Yun Chao Hu, Eindhoven (NL); Yi Cheng, Spanga (SE); Orjan Sahlin, Sollentuna (SE); Andreas Bjarlestam, Stockholm (SE); Johan Hjelm, Tokyo (JP); Nilo Mitra, New York, NY (US)

Correspondence Address: ERICSSON INC., 6300 LEGACY DRIVE, M/S EVR 1-C-11, PLANO, TX, 75024, US

(73) Assignee: TELEFONAKTIEBOLAGET LM ERICSSON (PUBL), Stockholm (SE)

(21) Appl. No.: 11/773,424

(22) Filed: Jul. 4, 2007

(51) Int. Cl. H04L 9/00; G06F 15/16

(52) U.S. Cl. 713/151; 709/228

(57) ABSTRACT

Systems and methods according to the present invention address this need and others by providing methods and systems for translating media encrypted by various Digital Rights Management (DRM) techniques. This allows end user equipment to receive media in an IMS/IPTV environment when the end user equipment uses a DRM that is different from the media server which is providing the desired media in both unicast and multicast applications.

### TECHNICAL FIELD

The present invention relates generally to telecommunications systems and in particular to methods and systems for sending and receiving media between devices that use Digital Rights Management (DRM) techniques.

### BACKGROUND

As the level of technology increases, the options for communications have become more varied. For example, in the last 30 years in the telecommunications industry, personal communications have evolved from a home having a single rotary dial telephone, to a home having multiple telephone, cable and/or fiber optic lines that accommodate both voice and data. Additionally cellular phones and Wi-Fi have added a mobile element to communications. Similarly, in the entertainment industry, 30 years ago there was only one format for television and this format was transmitted over the air and received via antennas located at homes. This has evolved into both different standards of picture quality such as, standard definition TV (SDTV), enhanced definition TV (EDTV) and high definition TV (HDTV), and more systems for delivery of these different television display formats such as cable and satellite. Additionally, services have grown to become overlapping between these two industries. As these systems continue to evolve in both industries, the service offerings will continue to merge and new services can be expected to be available for a consumer. Also these services will be based on the technical capability to process and output more information, for example as seen in the improvements in the picture quality of programs viewed on televisions, and therefore it is expected that service delivery requirements will continue to rely on more bandwidth being available throughout the network including the “last mile” to the end user.

Another related technology that impacts both the communications and entertainment industries is the Internet. The physical structure of the Internet and associated communication streams have also evolved to handle an increased flow of data. Servers have more memory than ever before, communications links exist that have a higher bandwidth than in the past, processors are faster and more capable and protocols exist to take advantage of these elements. As consumers' usage of the Internet grows, service companies have turned to the Internet (and other IP networks) as a mechanism for providing traditional services. These multimedia services include Internet Protocol television (IPTV, referring to systems or services that deliver television programs over a network using IP data packets), video on demand (VOD), voice over IP (VoIP), and other web related services received singly or bundled together.

To accommodate the new and different ways in which IP networks are being used to provide various services, new network architectures are being developed and standardized. One such development is the Internet Protocol Multimedia Subsystem (IMS). IMS is an architectural framework for delivering IP multimedia services to an end user. IMS architecture has evolved into a service-independent topology which uses IP protocols, e.g., SIP signaling to provide a convergence mechanism for disparate systems. In part this is accomplished via the provision of a horizontal control layer which isolates the access network from the service layer. More details regarding IMS architectures are provided below. Among other things, IMS architectures may provide a useful platform for the rollout of IPTV systems and services.

As different companies start to offer these new services, e.g., IPTV over IMS architectures, different forms of Digital Rights Management (DRM) will likely be used to control the accessibility of various forms of media. The acronym “DRM” refers to a number of different technologies used to control access to media and restrictions used in specific instances for accessing either the media itself or a device that either contains the media or allows a user to use the media, such as a set-top box. Through the use of DRM, both content providers and service providers can encrypt content and allow only authorized devices (or end users) to decrypt the content by distributing the keys required for decryption only to authorized users. As will be appreciated by those skilled in the art given the large number of different content providers, service providers, types of media and types of devices, a number of different DRM techniques are in use. This multitude of DRM techniques can make it difficult to ensure that end users are able to appropriately access the media that they wish to purchase. For example, due to the multitude of DRM techniques available in the market currently, it may be the case that two interconnected devices will be not able to share desired media if the two devices do not support the same DRM technique that is associated with the desired media.

Accordingly exemplary embodiments described below address the need for a network entity and methods which facilitate DRM transformations.

### SUMMARY

Systems and methods according to the present invention address this need and others by providing techniques and devices which facilitate DRM translation, and hence inter-working between different DRM schemes.

According to one exemplary embodiment a method for communicating between media devices, includes: requesting media by initiating Session Initiation Protocol (SIP) signaling between the devices, wherein the SIP signaling includes a Session Description Protocol (SDP) which contains a parameter describing a type of Digital Rights Management (DRM) used by a requesting media device.

According to another exemplary embodiment a method for translating media based upon Digital Rights Management (DRM) type includes: receiving a Session Initiation Protocol (SIP) message requesting the media including a DRM type parameter; and replacing a return IP address in the SIP message with an IP address associated with a decryption unit selected from a plurality of IP addresses.

According to yet another exemplary embodiment a communications node includes: a memory for controlling the plurality of encryption and decryption units; and a processor for controlling the plurality of encryption and decryption units, wherein Session Initiation Protocol (SIP) signaling information is received which contains Session Description Protocol (SDP) information which contains a parameter describing a Digital Rights Management (DRM) type associated with a device which is requesting media, further wherein the parameter is used by the processor to control at least one of the plurality of encryption and decryption units.

According to yet another exemplary embodiment a method for transmitting a broadcast from a node includes: receiving a media stream, at the node, which has been encrypted by a first type of Digital Rights Management (DRM); decrypting the media stream; re-encrypting the media stream into a plurality of different DRM types; and transmitting a plurality of media streams wherein each of the media streams is encrypted with a different type of DRM.

According to yet another exemplary embodiment a communications node includes: a memory for storing information associated with a plurality of encryption and decryption units; and; a processor for controlling routing of media communications to the plurality of decryption units, wherein one of the plurality of decryption units receives a media communication encrypted with a first Digital Rights Management (DRM) type, decrypts the media communication and transmits the decrypted media communication to the plurality of encryption units; and the plurality of encryption units, wherein each of the plurality of encryption units that receives the decrypted media communication re-encrypts the decrypted media communication with a different DRM type and transmits the re-encrypted media communication.

### BRIEF DESCRIPTION OF THE DRAWINGS

The accompanying drawings illustrate exemplary embodiments, wherein:

FIG. 1 depicts an overview of system elements that interact with Digital Rights Management according to exemplary embodiments;

FIG. 2 depicts an IMS architecture according to exemplary embodiments;

FIG. 3 illustrates an IMS-IPTV system according to exemplary embodiments;

FIG. 4 shows media communications in a unicast environment according to exemplary embodiments;

FIG. 5 depicts a Session Description Protocol message according to exemplary embodiments;

FIG. 6 depicts a Digital Rights Management gateway according to exemplary embodiments;

FIG. 7 shows media communications in a multicast environment according to exemplary embodiments; and

FIG. 8 depicts a server according to exemplary embodiments.

### DETAILED DESCRIPTION

The following detailed description of the exemplary embodiments refers to the accompanying drawings. The same reference numbers in different drawings identify the same or similar elements. Also, the following detailed description does not limit the invention. Instead, the scope of the invention is defined by the appended claims.

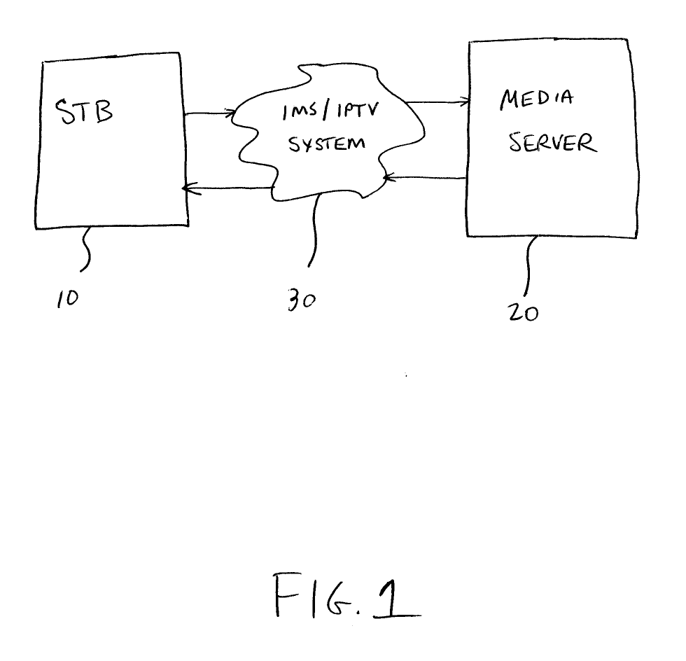

As described above, when different devices that use different Digital Rights Management (DRM) techniques attempt to communicate and transfer media, this media transfer may not work properly because not all types of DRM are mutually compatible. For example, as shown in FIG. 1, assume an end user has a set-top box 10 from manufacturer A and is attempting to obtain media, e.g., a video-on-demand (VoD) program, from a media server 20 associated with service provider B via an Internet Protocol Multimedia Subsystem (IMS)/Internet Protocol television (IPTV) system 30. The end user may not be able to access or use the media from service provider B unless the involved devices i.e., set-top box 10 and the media server 20, utilize the same DRM. For example, if the set-top box 10 does not have access to the decryption key that corresponds to the encryption key associated with a particular DRM technique used to encrypt the media which the set-top box 10 has requested from the media server 20, then it may be unable to access the media unless it is provided with that decryption key. According to exemplary embodiments, a solution for this problem is to provide a Digital Rights Management application server (DRM AS) which provides DRM compatibility functionality between a media server (or any other device that provides a desired service or media that has DRM associated therewith) and a set-top box (or any other end user device) as described in more detail below.

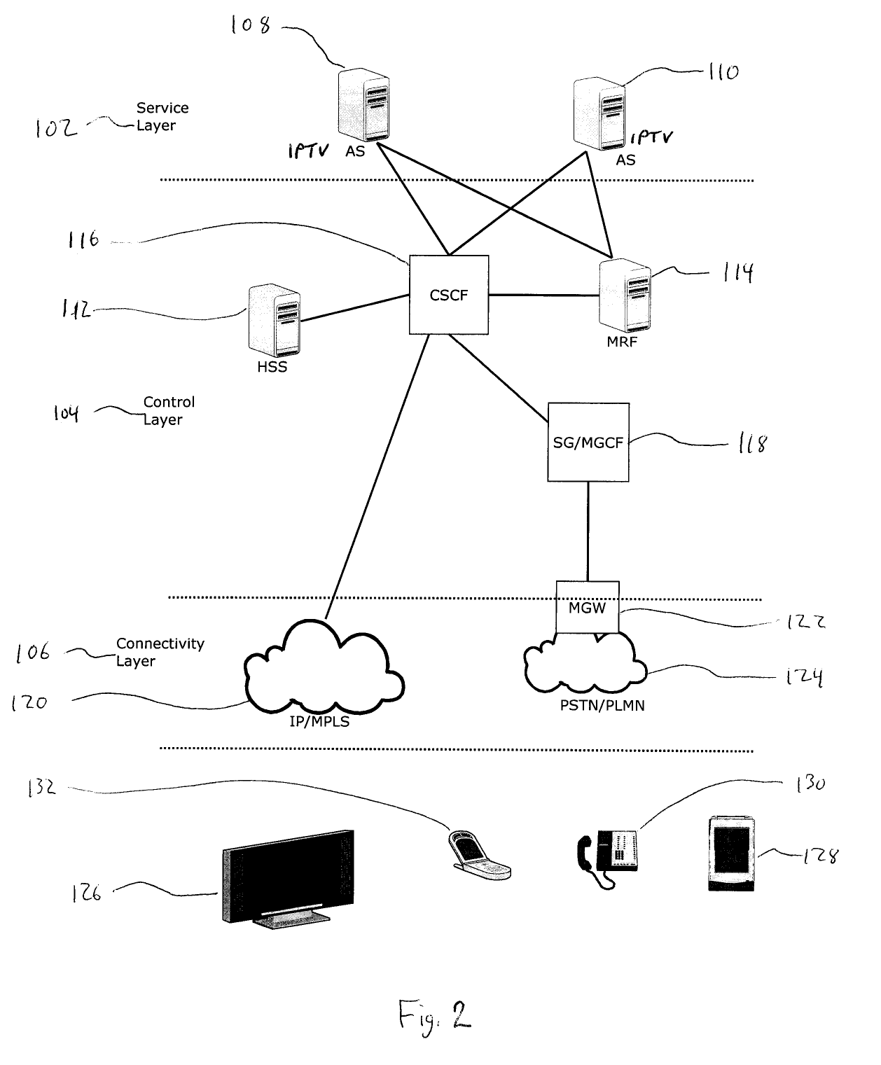

In order to provide some context for his discussion, a brief discussion of an exemplary IMS/IPTV system 30 in which exemplary embodiments can be implemented will now be described with respect to FIG. 2. As shown in FIG. 2, the architecture used in an IMS/IPTV system can be broken down into three layers: (1) a service layer 102, (2) a control layer 104, and (3) a connectivity layer 106. The service layer 102 includes IPTV application servers (ASs) 108, 110 which contain services and applications that can be delivered to an end user, e.g., Internet Protocol Television (IPTV) services. The control layer 104 includes a home subscriber server (HSS) 112, a media resource function (MRF) 114, a call service control function (CSCF) 116, a signaling gateway/media gateway control function (SG/MGCF) 118 and a media gateway 122. These elements in the control layer 104 are typically used for managing session set-up, resource modification and release of resources. The connectivity layer 106 includes routers and switches used in both the backbone network and the access network. These elements are shown in the Figure by Internet Protocol (IP)/multi-protocol label switching (MPLS) 120, the public switched telephone network (PSTN)/public land mobile network (PLMN) 124 and media gateway 122. This connectivity layer 106 is used to connect various end user devices to either each other or a variety of services and applications. Some types of end user devices are, for example, web TV 126 which is capable of displaying television signals received in an IP format, personal digital assistant (PDA) 128, telephone 130, and cell phone 132. It is to be appreciated that more or fewer elements can exist in an IMS architecture.

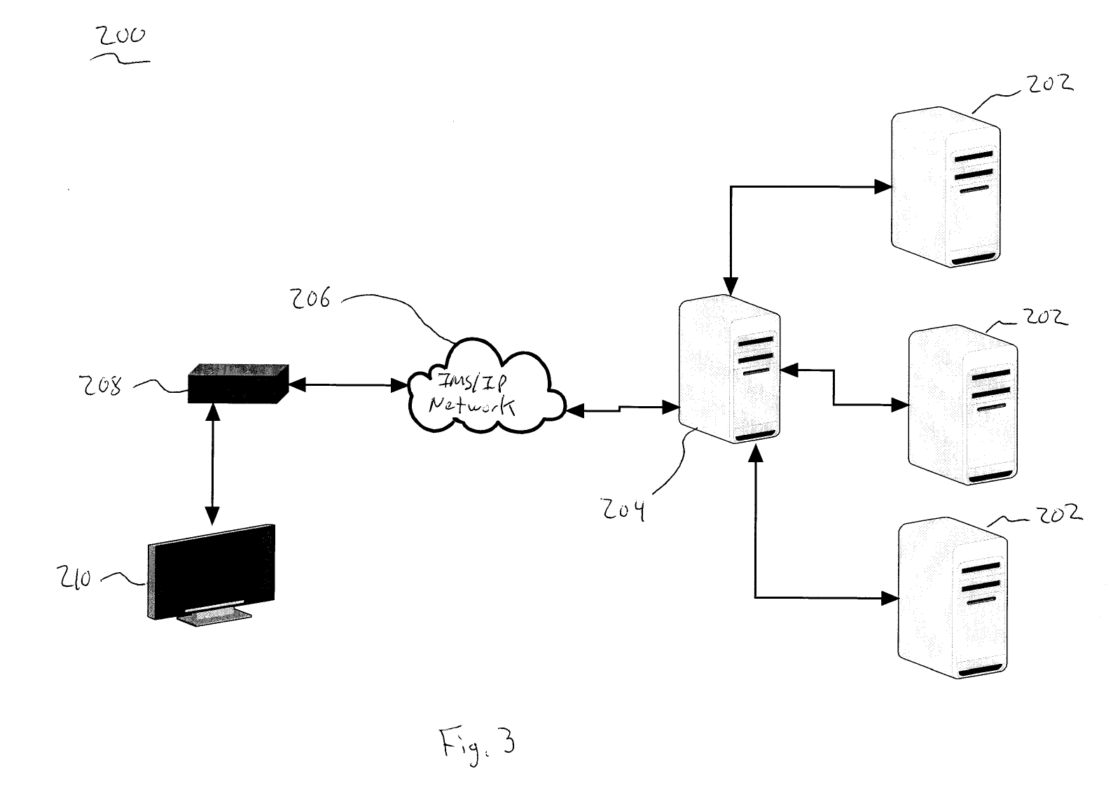

Focusing now on the application servers and end user devices in FIG. 3, the IMS-IPTV system 200 according to this exemplary embodiment includes a media server 202, a DRM AS 204, an IMS network 206, a set-top box 208 and a web TV 210. The web TV 210 is, in this example, capable of displaying a variety of video signals and can also be used for voice communications. Set-top box 208 typically can be used to control inputs to web TV 210 and is in communications with both web TV 210 and IMS network 206. IMS network 206 contains the elements such as routers, nodes, etc. (not shown) used to connect the end user to desired services and contains the ability to communicate with set-top box 208 for authentication/authorization purposes if required.

According to these exemplary embodiments, IMS network 206 is in communication with a DRM AS 204 which in turn is in communication with various media servers 202. Media servers 202 contain media that an end user desires to view upon web TV 210. DRM AS 204 is used to coordinate communications between set-top box 208 and media servers 202 as well as to ensure that any possible DRM issues are resolved by, for example, performing encryption translations as will be described below. Additionally, in this example, set-top box 208 acts as a communications node for accessing an IMS network 206. Alternatively, a separate device such as a modem or a router could be used to connect the set-top box 208 and web TV 210 to the IMS network 206.

According to exemplary embodiments, communications regarding media transmissions can be broken down generally into two broadcast types: (1) unicast and (2) multicast. A unicast message is a message sent from a single source to a single receiving device, whereas a multicast message is a message sent from a single source to multiple receiving devices. For example, if an end user had requested to watch a movie as a part of a VoD service, the message would be sent out as a unicast message stream since only the end user would be watching that movie at this specific time with his or her control options, such as, play, pause or fast forward. By way of contrast, for an end user that requests a regularly scheduled TV program that is currently being broadcasted to a plurality of end users, this TV program can be transmitted as a multicast stream. In the following exemplary embodiments communications between devices are described for devices which may employ the same or different DRM techniques.

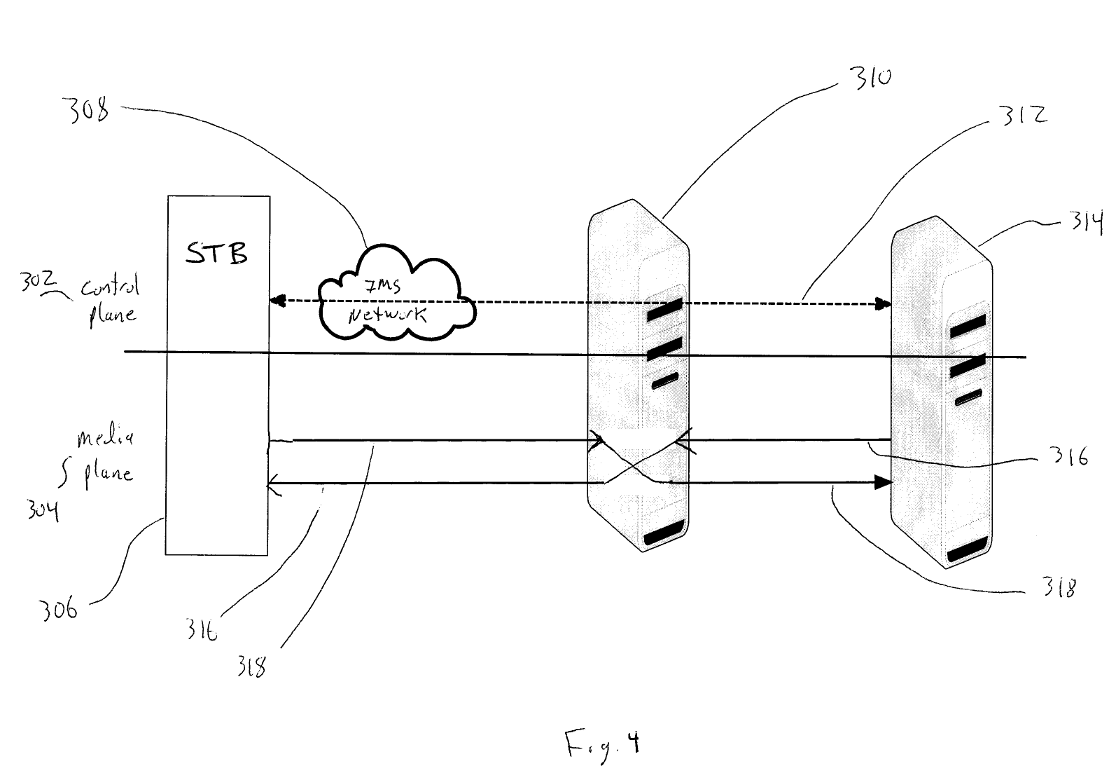

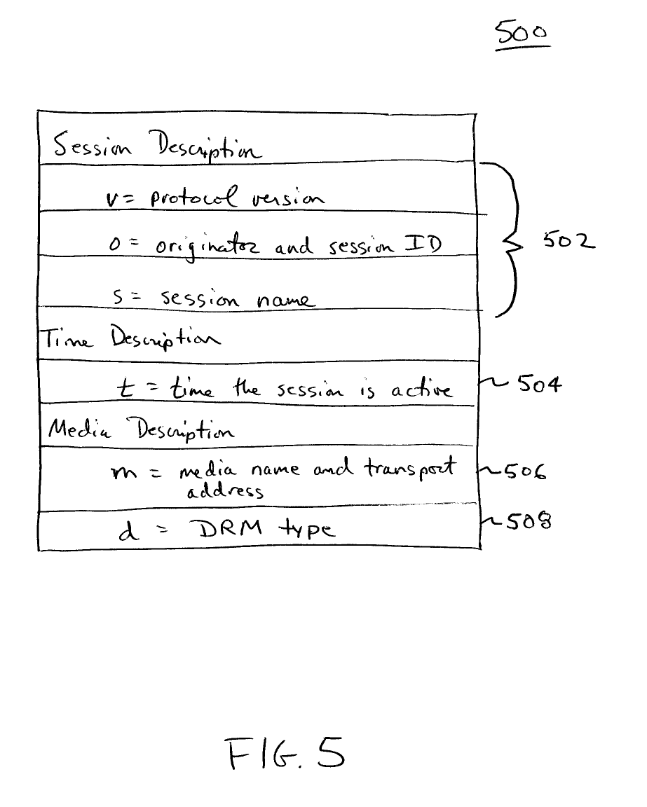

Beginning with exemplary unicast communications, DRM handling techniques and systems will now be discussed with respect to FIG. 4 in which set-top box 306 uses a first type of DRM and media server 314 uses a second (different) type of DRM. Control communications 312 occur in the control (or signaling) plane 302 between the set-top box 306, the IMS network 308, the DRM AS 310 and the media server 314. According to these exemplary embodiments, control communications 312 typically utilize Session Initiation Protocol (SIP) during the signaling portion of a communication session in conjunction with Session Description Protocol (SDP) which is used to describe the session including media content of the desired service. The SDP generally contains the information needed to enable devices to join into a session with each other. According to exemplary embodiments, the SDP can include three general types of description information: session description, time description, and media description information. Each of these types of description information has their own set of parameters. An example of the format for an SDP description including DRM type used according to these exemplary embodiments is shown in FIG. 5 wherein SDP 500 contains Session Description parameters 502, Time Description parameter 504 and Media Description parameters 506 and 508. SDP is described in greater detail in Network Working Group Request For Comments 4566 dated July 2006 and is incorporated herein by reference.

For this exemplary embodiment a new parameter is carried by the SIP control signaling, e.g., parameter 508 within the SDP description, which describes the type of DRM used by a device (e.g., STB 306 or media server 314) when the SIP session is set up. One example of a SIP response that can carry the new parameter within the SDP is a response message, e.g., 200 OK, which could then also include the type of DRM used by the media device. This exemplary scheme also allows for the offer/answer model for SDP negotiation between peers to be used. For example, when the DRM AS 310 intercepts a SIP INVITE message from an originator, a variety of other DRM types that are supported by the DRM AS 310 in addition to the DRM type of the originator are captured in the new parameter within the SDP as provided by the originator. This then allows the end user device to select the DRM type that is supported from the available DRM types provided in the now further modified SDP information included in the corresponding 200 OK message. Note however that the new parameter 508 can be disposed within other portions of the SDP 500 or labeled in other ways as long as some element carried by the SIP signaling provides information relating to DRM type that can be used by the DRM AS 310 to facilitate the DRM translation described below. For example, in the SIP control signaling from STB 306, the parameter 508 in the SDP would describe the DRM of set-top box 306 and in the SIP control signaling from the media server 314, the parameter 508 in the SDP would describe the DRM of media server 314.

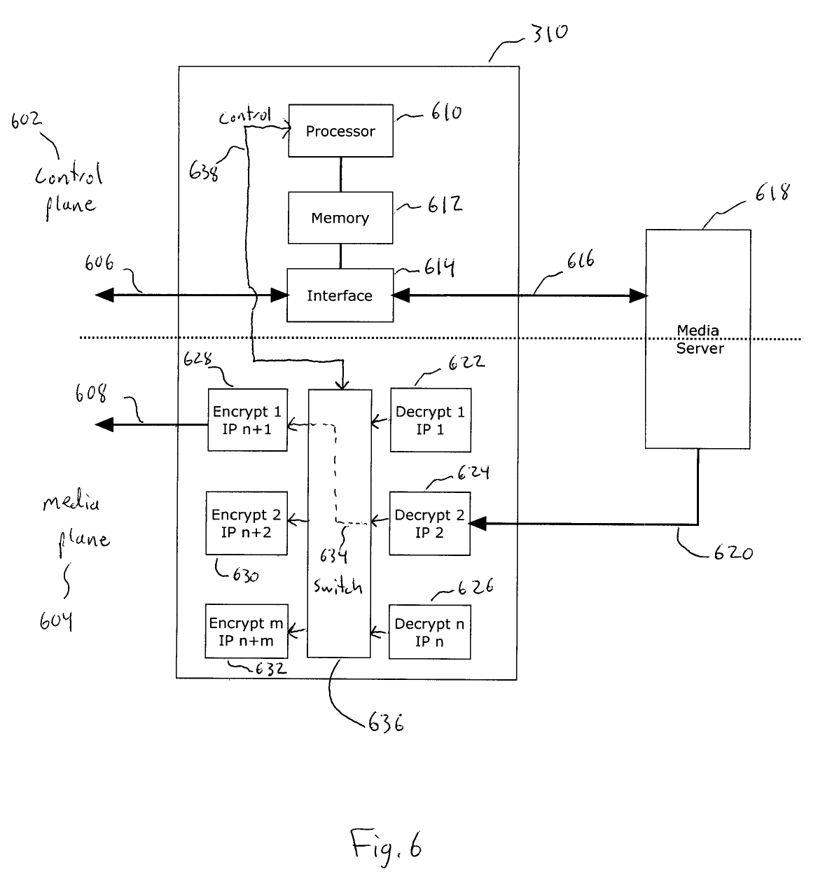

The DRM parameter 508 in the SDP 500 provides the DRM AS 310 with the information that it needs to perform appropriate DRM translation of media streams as they are sent between devices 306 and 314. Thus, at a minimum, the DRM type parameter 508 will enable the DRM AS 310 to identify the specific type of encryption used by a media stream or device. This information can be used in a number of different ways. For example, as seen in FIG. 6 and described in more detail below, control signaling allows the control portion of the DRM AS 31 0 to change the return IP addresses provided in the SIP signaling associated with media requests to ensure that the media from media server 314 goes to the correct hardware in DRM AS 310 for encryption translation prior to delivery of the media to set-top box 306. In other words, the control portion of the DRM AS 310 acts similarly to a back-to-back user agent (B2BUA) or as a DRM gateway (DRM G/W) which performs actions similar to session border gateways which open pinholes in firewalls for media transmission to pass through to the correct location.

As mentioned above, the information provided in the control signaling according to these exemplary embodiments allows the control portion of the DRM AS 310 to change the IP addresses carried by the SIP signaling to ensure that the media has its encryption appropriately translated prior to delivery. For example, the two addresses which can be captured and replaced in the SIP signaling are the address of the request originator for receiving the media, e.g., STB 306, and the address (where requests from the originator are intercepted) of the media device that encrypts the media prior to transmission, e.g. media server 310. These two addresses are typically conveyed via the SIP INVITE and the 200 OK messages used during session initiation/setup. The DRM AS 310 will typically replace these two addresses with the addresses of the appropriate DRM decryption and encryption devices, respectively.

In order for this DRM translation to occur, the control signaling re-routes the media based upon the DRM type parameter 508 in the SDP as shown in FIG. 6. Therein, according to exemplary embodiments, the DRM AS 310 contains a processor 610, a memory 612, and a communications interface 614 which are linked together. Additionally, the DRM AS 310 contains decryption devices (622, 624 and 626) and encryption devices (628, 632 and 634). The encryption and decryption devices may be implemented purely in hardware, purely in software running on a general purpose processor or some combination thereof. Each of these decryption and encryption devices has a unique IP address and is able to both transmit and receive media data. The linked processor 610, memory 612 and communications interface 614 are able to communicate with the encryption and decryption devices as necessary through control link 638 to switch 636 to perform such functions as, for example, the transmission of information and instructions.

The decryption devices (622, 624 and 626) receive media communications 620 from media server 618 and decrypt the received media communications 620. The decrypted media is then transmitted as media communication 634 through switch 636 which routes the decrypted media to the appropriate encryption unit based upon received instructions from processor 610 via control link 638 to one of the encryption devices (628, 630 and 632) for encryption and transmission. The switch 636 can include hardware switches with embedded software that is configurable under control from the processor 610 and it is also capable of locally controlling the hardware units, e.g., encryption and decryption units. For each received media communication or stream, only one decryption device and one encryption device will typically be used depending upon the DRMs involved. Additionally, more or fewer components can be used in the DRM AS 310 as needed. Alternatively, the encryption and decryption units can be physically separated from the DRM AS 310.

For example, when an end user requests access to media, a session is initiated through the use of signaling messages. SIP signaling messages 606 and 616 occur in the control plane between communications interface 614 and an IPTV client (not shown) and between communications interface 614 and a media server 618, respectively. These SIP signaling messages are used for session setup and include SDPs that contain session setup information such as DRM type information and an IP address associated with the requesting device. The information contained in the SIP signaling messages is stored in DRM AS 310 and is used to modify media request messages in order to alter the IP address of the destination of media communications 620 from media server 618 i.e., from the return IP address of the requesting end user device to an IP address of a decryption engine associated with the DRM type of the media server 618. Additionally, it is to be understood that since the DRM of the media device would not necessarily be known by the DRM AS 310 until the reception of the appropriate 200 OK message, the DRM AS 310 could need to update the SIP session at a later time using a SIP UPDATE message(s).

For example, suppose that the requesting IPTV client uses DRM type 1 and the media server 618 uses DRM type 2. In this example, the DRM AS 310 receives a media request from the IPTV client via SIP signaling which indicates among other things, its DRM type, its IP address (i.e., a return IP address to which the requested media is to be sent) and the identity of the media server 618. The DRM AS 310 modifies this SIP signal based on the media server 618's DRM type, specifically substituting the IP address IP2 for the IPTV client's IP address, and including other DRM types that the DRM AS 310 supports, and then transmits the modified SIP signal to media server 618. This results in media server 618 sending the requested media communications 620 to the IP address IP2, i.e., the IP address associated with Decrypt_2 624, which is capable of decrypting the type of DRM used by Media Server 618. Note that if the 200 OK response received from the media server 618 included a DRM type different than the one that Decrypt_2 624 supports, the DRM AS 310 sends an UPDATE message to the media server to alter the address, where media 620 is to be received. For example, if the DRM type has changed, the UPDATE message from the DRM 310 could contain a new IP address for media reception such as, IP1 or IP3.

Upon decryption, the media communications 634 are transmitted to Encrypt_1 engine 628 through switch 636 based upon instructions received through control link 638 from processor 610 for re-encryption using the DRM type of the requesting IPTV device. Decrypt_2 624 is aware of which encryption device to send media communications 634 to (or a controllable routing switch can be interposed between the decryption devices and the encryption engines) because the instructions were previously sent to Decrypt_2 624 from the control plane 602 or processor 610 regarding which encryption device is to be used based upon the DRM information for the IPTV client that was received by communications interface 614. Upon encryption, media communications 608 is sent to the IPTV client for use.

While this example primarily relates to transmitting media from the media server 618 to an end user, it is to be appreciated by one skilled in the art that a similar process can be used for communications from an end user back to the media server 618 that require DRM translation. In this exemplary embodiment, DRM AS 310 changed the IP address in the SDP to send media communications 620 to itself for encryption translation. Alternatively, the DRM AS 310 could have changed the IP address to that associated with other hardware capable of making the translations based upon the DRM parameter in the SDP.

The foregoing exemplary embodiments describe how DRM translation can be performed by a DRM AS 310 for unicast media streams. According to another exemplary embodiment, multicast media sent from a media server using a first type of DRM can be sent to multiple end users where the end users use types of DRM that differ from the first type of DRM used by the media server. For multicast applications a protocol such as Internet Group Management Protocol (IGMP) is used for joining a multicast stream. Accordingly, multicast media content that needs to be translated prior to being usable by an end user can be translated and routed through a DRM G/W according to other exemplary embodiments prior to being transmitted to an end user. Since different end users may themselves be using different types of DRM mechanisms which, in turn, may also be different than the type of DRM used by the media server, a mechanism for differentiating the end users in the context of multicast DRM handling is needed. To meet this need, each household's set-top box (or equivalent device) could store personalized data for the user, including DRM requirements. This allows the set-top box to join the correct DRM group when attempting to join a multicast session.

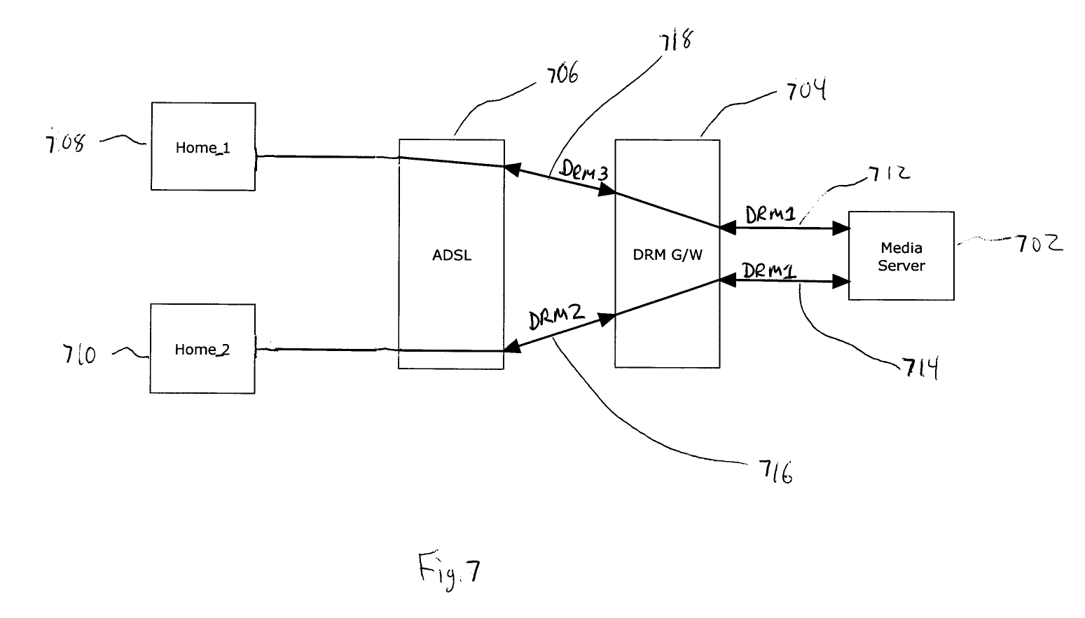

An exemplary system and method for performing DRM translation in a multicast environment will now be described with respect to FIG. 7. The exemplary multicast environment displayed in FIG. 7 contains a media server 702, a DRM G/W 704, asynchronous digital subscriber line ADSL 706 (which represents a communication path for delivery of media to the end user), and end user devices Home_1 708, and Home_2 710. Other supporting networks and network parts are understood to be in place for delivering the media and supporting communications, but are not particularly relevant for the explanation of DRM handling according to this exemplary embodiment and hence are not depicted in FIG. 7. Initially, media server 702 transmits media communications 712 and 714 using DRM1 to DRM G/W 704. Media communications 712 and 714 represent a multicast streaming of a program. The DRM G/W 704 translates the incoming media communications 712 and 714 into formats useable for the end users. In this case, media communication 716 has been translated into format for DRM2 and media communications 718 has been translated into a format for DRM3. DRM1, DRM2 and DRM3 in this example are all different types of DRM, e.g., they each use different types of encryption and each require a different decryption key. Media communications 716 and 718 are transmitted to ADSL for delivery to Home_2 and Home_3, respectively.

As illustrated in the exemplary multicast communications shown in FIG. 7, a DRM G/W 704 takes a single type of DRM media input, e.g. DRM 1, and outputs the same media content into a plurality of streams using different DRMs, e.g., DRM2 and DRM3. It is to be appreciated by one skilled in the art that there can be significantly more output streams being transmitted by the DRM G/W 704 that include the same media with different DRM types. This plurality of DRM media streams being output are joined by end users through the IGMP JOIN messaging process. The information required by the end users regarding the DRM schemes (or types) used by different multicast streams can be included in the metadata (Electronic Program guide) received by a device, e.g., a set-top box, during power up. Since the set-top box knows the type of DRM that it uses, the set-top box picks the correct multicast address based upon both its DRM and the DRM/address information provided in the received metadata.

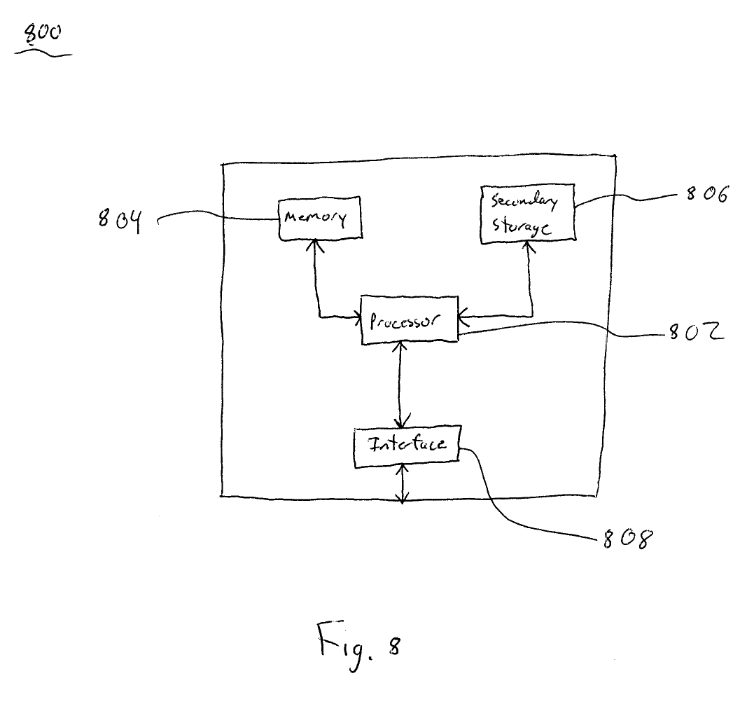

The exemplary embodiments described above provide for messages and protocols involving media communications. An exemplary server 800 will now be described with respect to FIG. 8. Server 800 can contain a processor 802 (or multiple processor cores), memory 804, one or more secondary storage devices 806 and an interface unit 808 to facilitate communications between network node 800 and the rest of the network. Additionally, the server 800 can contain control protocols allowing control plane communications to communicate with the media plane to ensure that the proper hardware (and/or software) is used to perform translation(s). The memory (or the secondary storage) can be used for storage of exemplary items such as information regarding the hardware/software devices, including their respective IP addresses, which are available to translate different types of DRMs and the devices, including their respective IP addresses, which are available to act as DRM G/W's. Alternatively, a variety of other techniques can be used to inform server 800 of the IP addresses and types of hardware available for use in translating different DRMs. Thus, a network node according to an exemplary embodiment may include a processor for transmitting and receiving messages associated with media encryption translations for devices that utilize different types of DRM.

The above-described exemplary embodiments are intended to be illustrative in all respects, rather than restrictive, of the present invention. All such variations and modifications are considered to be within the scope and spirit of the present invention as defined by the following claims. No element, act, or instruction used in the description of the present application should be construed as critical or essential to the invention unless explicitly described as such. Also, as used herein, the article “a” is intended to include one or more items.

What is claimed is:

1. A method for communicating between media devices, comprising:
requesting media by initiating Session Initiation Protocol (SIP) signaling between said devices, wherein said SIP signaling includes a Session Description Protocol (SDP) which contains a parameter describing a type of Digital Rights Management (DRM) used by a requesting media device.

2. The method of claim 1, further comprising:
receiving said requested media which has been encrypted with a first type of DRM;
decrypting said requested media;
re-encrypting said requested media with a second type of DRM based upon said parameter; and
forwarding said re-encrypted, requested media to said requesting device.

3. The method of claim 1, further comprising:
changing an Internet Protocol (IP) address associated with said requesting media device in said SIP signaling to a different IP address based upon said parameter.

4. The method of claim 3, wherein said different IP address is an IP address of at least one device capable of translating media based upon said DRM types used by said devices.

5. The method of claim 1, wherein said media devices include a media server and a device associated with a media player.

6. A method for translating media based upon Digital Rights Management (DRM) type comprising:
receiving a Session Initiation Protocol (SIP) message requesting said media including a DRM type parameter; and
replacing a return IP address in said SIP message with an IP address associated with a decryption unit selected from a plurality of IP addresses.

7. The method of claim 6, further comprising:
receiving said requested media at said IP addresses;
decrypting said requested media;
re-encrypting said requested media with an encryption type based upon said DRM type parameter; and
forwarding said re-encrypted, requested media.

8. A communications node comprising:
a memory for storing information associated with a plurality of encryption and decryption units; and
a processor for controlling said plurality of encryption and decryption units,
wherein Session Initiation Protocol (SIP) signaling information is received by said node which contains Session Description Protocol (SDP) information that contains a parameter describing a Digital Rights Management (DRM) type associated with a device which is requesting media, further wherein said parameter is used by said processor to control at least one of said plurality of encryption and decryption units.

9. The communication node of claim 8, wherein said plurality of encryption and decryption units are each associated with a DRM type, and each associated with an IP address.

10. The communications node of claim 8, wherein said processor changes an Internet Protocol (IP) address associated with said requesting media device in said SIP signaling to a different IP address based upon said a DRM type associated with said requested media.

11. The communications node of claim 10, wherein said different IP address is an IP address of at least one of said decryption units.

12. The communications node of claim 9, wherein said node receives said requested media which has been encrypted with a first type of DRM and wherein:
one of said decryption units decrypts said requested media and routes said decrypted requested media to one of said encryption units;
said one of said encryption units re-encrypts said requested media with a second type of DRM based upon said parameter and forwards said re-encrypted, requested media to said requesting device.

13. The communications node of claim 8, wherein said device is a device associated with a media player.

14. The communications node of claim 13, wherein said device is a set-top box.

15. The communications node of claim 8, wherein said node is a DRM gateway.

16. A method for transmitting a broadcast from a node comprising:
receiving a media stream, at said node, which has been encrypted by a first type of Digital Rights Management (DRM);
decrypting said media stream;
re-encrypting said media stream into a plurality of different DRM types; and
transmitting a plurality of media streams wherein each of said media streams is encrypted with a different type of DRM.

17. The method of claim 16, wherein said broadcast is a multicast broadcast.

18. The method of claim 16, further comprising:
receiving one of said plurality of transmitted media streams by an end user based upon previously received metadata and the DRM of said end user.

19. The method of claim 18, wherein said metadata includes DRM types.

20. A communications node comprising:
a memory for storing information associated with a plurality of encryption and decryption units; and
a processor for controlling routing of media communications to said plurality of encryption and decryption units,
wherein one of said plurality of decryption units receives a media communication encrypted with a first Digital Rights Management (DRM) type, decrypts said media communication and transmits said decrypted media communication to said plurality of encryption units; and
said plurality of encryption units, wherein each of said plurality of encryption units that receives said decrypted media communication re-encrypts said decrypted media communication with a different DRM type and transmits said re-encrypted media communication.
